(19) United States
(12) Patent Application Publication
(10) Pub. No.: US 2026/0351604 A1
(43) Pub. Date: Nov. 5, 2026

(54) NEGATIVE ELECTRODE FOR RECHARGEABLE LITHIUM BATTERY, METHOD FOR MANUFACTURING THE SAME, AND RECHARGEABLE LITHIUM BATTERY INCLUDING THE SAME

(71) Applicant: SAMSUNG SDI CO., LTD., Yongin-si (KR)

(72) Inventors: Minji KIM, Yongin-si (KR); Injoe Jung, Yongin-si (KR)

(73) Assignee: SAMSUNG SDI CO., LTD., Yongin-si (KR)

(21) Appl. No.: 19/563,172

(22) Filed: Mar. 11, 2026

(30) Foreign Application Priority Data
Apr. 30, 2025 (KR) 10-2025-0057537

(51) Int. Cl. H01M 4/583; H01M 4/02; H01M 4/04; H01M 4/133; H01M 4/134; H01M 4/38; H01M 4/40; H01M 10/0525

(52) U.S. Cl. CPC H01M 4/583; H01M 4/0471; H01M 4/133; H01M 4/134; H01M 4/386; H01M 4/405; H01M 10/0525; H01M 2004/021; H01M 2004/027

(57) ABSTRACT

The present disclosure relates to a negative electrode for a rechargeable lithium battery, a method for manufacturing the negative electrode, and a rechargeable lithium battery including the negative electrode. A negative electrode includes a negative electrode current collector, a first negative electrode active material layer on the negative electrode current collector, and a second negative electrode active material layer on a surface of the first negative electrode active material layer. The first negative electrode active material layer includes a first binder. The second negative electrode active material layer includes a second binder.

### CROSS-REFERENCE TO RELATED APPLICATION

This U.S. nonprovisional application claims priority under 35 U.S.C § 119 to Korean Patent Application No. 10-2025-0057537 filed on Apr. 30, 2025 in the Korean Intellectual Property Office, the disclosure of which is hereby incorporated by reference in its entirety.

### BACKGROUND

The present disclosure relates to a negative electrode for a rechargeable lithium battery, a method for manufacturing the negative electrode, and a rechargeable lithium battery including the negative electrode.

With increasing presence of battery-powered electronic devices such as, e.g., mobile phones, notebook computers, electric vehicles, and the like, the demand for rechargeable batteries with high energy density and large capacity is increasing. Accordingly, enhancing the performance of rechargeable lithium batteries may be advantageous.

A rechargeable lithium battery generally includes a positive electrode, a negative electrode, and an electrolyte. Both the positive and negative electrodes contain active materials capable of lithium-ion intercalation and deintercalation. Electrical energy is generated through oxidation and reduction reactions as lithium ions move between the electrodes during charging and discharging.

### SUMMARY

An example embodiment the present disclosure includes a negative electrode for a rechargeable lithium battery having high capacity and fast charging characteristics, and a rechargeable lithium battery including the negative electrode.

According to an example embodiment of the present disclosure, a negative electrode for a rechargeable lithium battery may include a negative electrode current collector, a first negative electrode active material layer on the negative electrode current collector, and a second negative electrode active material layer on a surface of the first negative electrode active material layer. The first negative electrode active material layer may include a first binder. The second negative electrode active material layer may include a second binder. The second negative electrode active material layer may include one surface and the other surface opposite to the one surface, the other surface being in contact with the first negative electrode active material layer. The first negative electrode active material layer may have a first point adjacent to the surface of the first negative electrode active material layer, and a second point located in a center portion of the first negative electrodes active material layer. The second negative electrode active material layer may have a third point adjacent to the one surface of the second negative electrode active material layer, and a fourth point located in a center portion of the second negative electrode active material layer. When the negative electrode active material layer is measured by a Surface and Interfacial Cutting Analysis System (SAICAS), at least one of the following conditions is satisfied: a first horizontal binding force (Fₕ₁) at the first point is less than or equal to a second horizontal binding force (Fₕ₂) at the second point; a third horizontal binding force (Fₕ₃) at the third point is less than or equal to a fourth horizontal binding force (Fₕ₄) at the fourth point; or the first horizontal binding force is less than or equal to the second horizontal binding force, and the third horizontal binding force is smaller than or equal to a fourth horizontal binding force.

According to an example embodiment of the present disclosure, a method for manufacturing a negative electrode may include preparing a negative electrode current collector, forming a first negative electrode active material layer on the negative electrode current collector, forming a second negative electrode active material layer on the first negative electrode active material layer, and performing a surface treatment process on at least one of the first negative electrode active material layer, the second negative electrode active material layer, or both, to remove a binder in a surface portion.

According to an example embodiment of the present disclosure, a rechargeable lithium battery may include the negative electrode described above, a positive electrode, and the separator between the negative electrode and the positive electrode.

### BRIEF DESCRIPTION OF DRAWINGS

FIG. 1 is a schematic conceptual diagram of a rechargeable lithium battery according to example embodiments of the present disclosure.

Each of FIG. 2 to FIG. 5 is a schematic diagram illustrating a rechargeable lithium battery according to an example embodiment of the present disclosure.

FIG. 6 is a cross-sectional view of a negative electrode for a rechargeable lithium battery according to example embodiments of the present disclosure.

FIG. 7 is a cross-sectional view illustrating a negative electrode for a rechargeable lithium battery according to an example embodiment of the present disclosure, in which a region “M” of FIG. 6 is enlarged.

FIG. 8 is a diagram schematically illustrating a process of cutting a negative electrode active material layer using a Surface and Interfacial Cutting Analysis System (SAICAS).

FIG. 9 is a diagram for explaining a negative electrode for a rechargeable lithium battery according to an example embodiment of the present disclosure.

FIG. 10 and FIG. 11 are cross-sectional views illustrating a negative electrode for a rechargeable lithium battery according to another example embodiment of the present disclosure, showing an enlarged view of region “M” in FIG. 6.

FIG. 12 is a diagram for explaining a method for manufacturing a negative electrode for a rechargeable lithium battery according to an example embodiment of the present disclosure.

FIG. 13 and FIG. 14 are diagrams for explaining a method for manufacturing a negative electrode for a rechargeable lithium battery according to another example embodiment of the present disclosure.

FIG. 15 is a Surface-Interface Cutting Analysis System (SAICAS) result of a negative electrode according to example embodiments and comparative examples of the present disclosure.

FIG. 16 is a flow chart illustrating a method of manufacturing a negative electrode, according to an example embodiment.

### DETAILED DESCRIPTION

To fully understand the configuration and effects of the present disclosure, some example embodiments are described with reference to the accompanying drawings. However, the present disclosure is not limited to the following example embodiments and may be implemented in various forms. The example embodiments are provided solely to illustrate the present disclosure and to enable those skilled in the art to fully understand its scope.

In this description, when an element is described as being “on” another element, the element may be directly on the other element, or one or more intervening elements may be present therebetween. In the drawings, certain thicknesses may be exaggerated to better illustrate technical details. Throughout the specification, like reference numerals indicate like elements.

Unless otherwise explicitly stated in this description, singular forms may also include plural forms. In addition, unless explicitly stated otherwise, the phrase “A or B” may indicate “A but not B,” “B but not A,” and “A and B.” The terms “comprises/includes” and “comprising/including” do not exclude the presence or addition of one or more other components.

In this description, the phrase “combination thereof” may refer to a mixture, a stack, a composite, a copolymer, an alloy, a blend, or a reaction product.

Unless otherwise specifically defined, the term “particle diameter” refers to an average particle diameter. The particle diameter may represent the median particle size (D50), which corresponds to the diameter of particles at 50 vol % in a cumulative particle size distribution. The average particle diameter (D50) can be measured using known methods, such as, e.g., a particle size analyzer, transmission electron microscope (TEM) imaging, or scanning electron microscope (SEM) imaging. Alternatively, dynamic light scattering may be used, where particle counts within size ranges are analyzed to calculate the average particle diameter (D50). For example, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

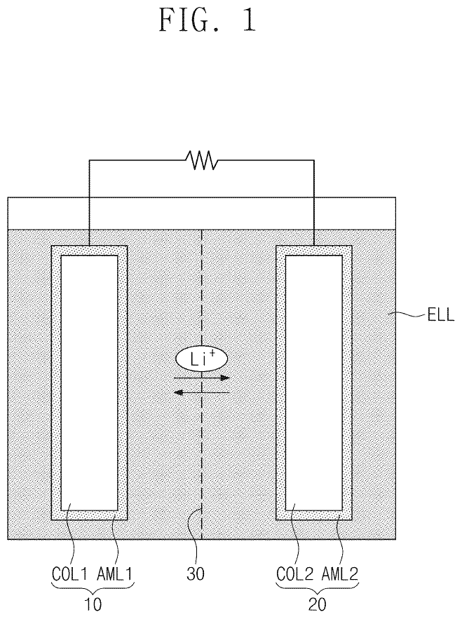

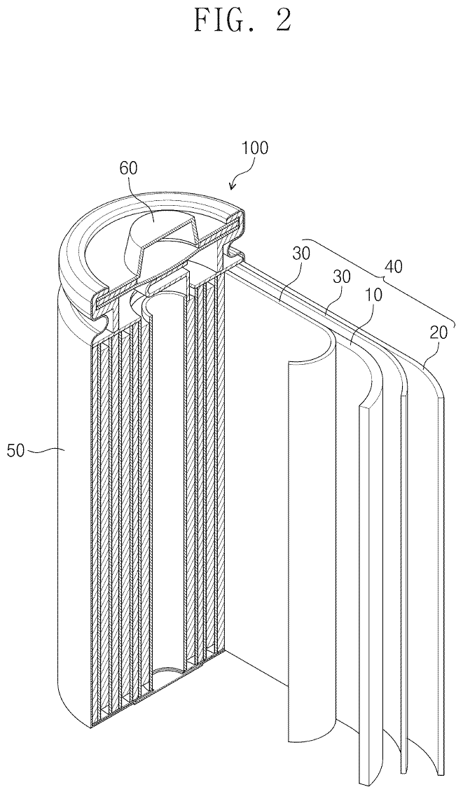

FIG. 1 is a simplified conceptual diagram illustrating a rechargeable lithium battery according to example embodiments of the present disclosure. Referring to FIG. 1, the rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1, and a positive electrode active material layer AML1 formed on the current collector COL1. The positive electrode active material layer AML1 may include a positive electrode active material, and may further include a binder and/or a conductive material.

For example, the positive electrode 10 may further include an additive that can constitute a sacrificial positive electrode.

An amount of the positive electrode active material may be in a range of about 90 wt % to about 99.5 wt % relative to 100 wt % of the positive electrode active material layer AML1. An amount of each of the binder and the conductive material may be in a range of about 0.5 wt % to about 5 wt % relative to 100 wt % of the positive electrode active material layer AML1.

The binder may improve attachment of positive electrode active material particles to each other, and improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause an adverse chemical change in a battery may be used as the conductive material. The conductive material may include, for example, a carbon-based material such as, e.g., natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, or a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn₂₋₆X₆O_{4-c}D_{c} (where 0.90≤a≤1.8, 0≤b≤0.5, and 0≤c≤0.05); LiₐNi_{1-b-c}Co_{b}X_{c}CO_{2-α}D_{α} (where 0.90≤a>1.8, 0≤b>0.5, 0≤c≤0.5, and 0<α<2); LiₐNi_{1-b-c}Mn_{b}X_{c}O_{2-α}D_{α} (where 0.90≤a>1.8, 0≤b>0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A may be or include at least one of Ni, Co, Mn, or a combination thereof, X may be or include at least one of Al, Ni, Co, Mn, Cr, Fe, Mg, Sr, V, a rare-earth element, or a combination thereof, D may be or include at least one of O, F, S, P, or a combination thereof, G may be or include at least one of Al, Cr, Mn, Fe, Mg, La, Ce, Sr, V, or a combination thereof, and L1 may be or include at least one of Mn, Al, or a combination thereof.

For example, the positive electrode active material may be or include a high-nickel-based positive electrode active material having a nickel amount that is equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve a high capacity, and may thus be applied to a high-capacity and a high-density rechargeable lithium battery.

### Negative Electrode 20

The negative electrode 20 for a rechargeable lithium battery may include a current collector COL2, and a negative electrode active material layer AML2 positioned on the current collector COL2. The negative electrode active material layer AML2 may include a negative electrode active material, and may further include a binder and/or a conductive material (e.g., an electrically conductive material).

For example, the negative electrode active material layer AML2 may include a negative electrode active material in a range of about 90 wt % to about 99 wt %, a binder in a range of about 0.5 wt % to about 5 wt %, and a conductive material in a range of about 0 wt % to about 5 wt %.

The binder may improve the attachment of negative electrode active material particles to each other, and improve the attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, or alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material that does not cause an adverse chemical change in a battery may be used as the conductive material. For example, the conductive material may include a carbon-based material such as at least one of natural graphite, artificial graphite, carbon black, acetylene black, ketjen black, carbon fiber, carbon nanofiber, and carbon nanotube; a metal-based material in the form of a metal powder or metal fiber including one or more of copper, nickel, aluminum, and silver; a conductive polymer such as a polyphenylene derivative; or a mixture thereof. The current collector COL2 may include at least one of a copper foil, a nickel foil, a stainless-steel foil, a titanium foil, a nickel foam, a copper foam, a polymer substrate coated with a conductive metal, or a combination thereof.

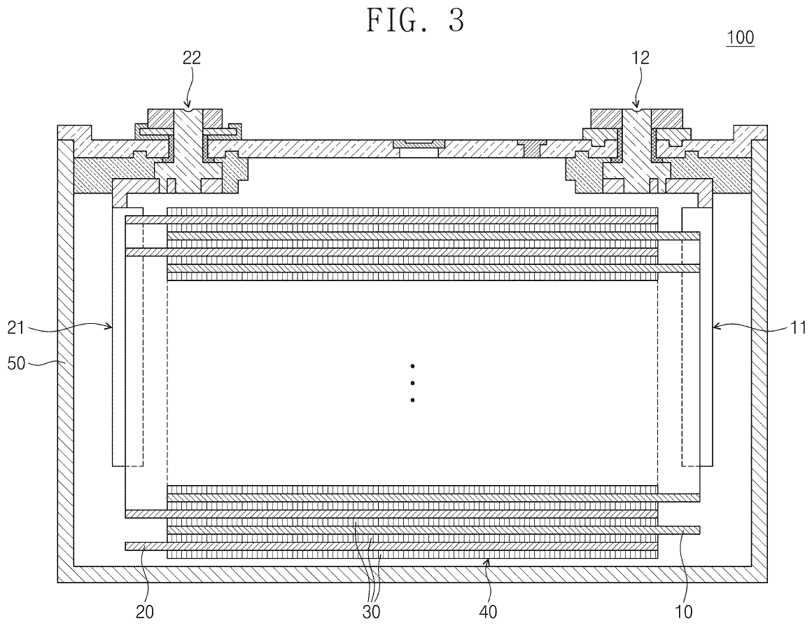

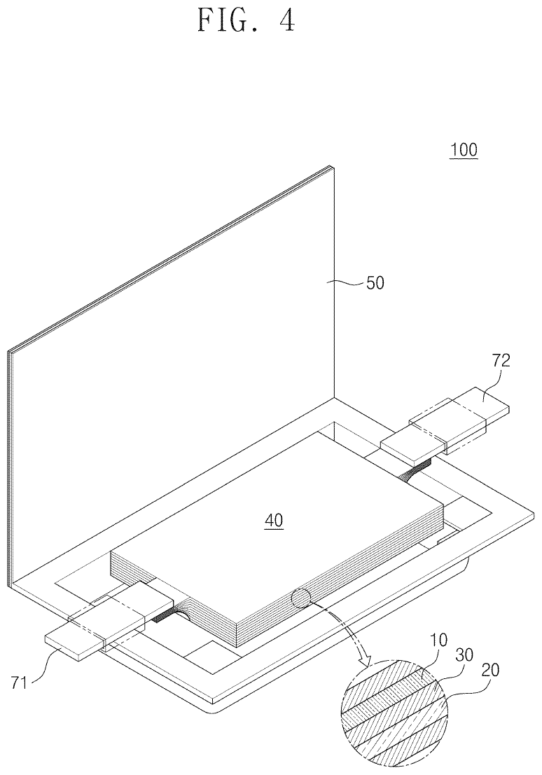

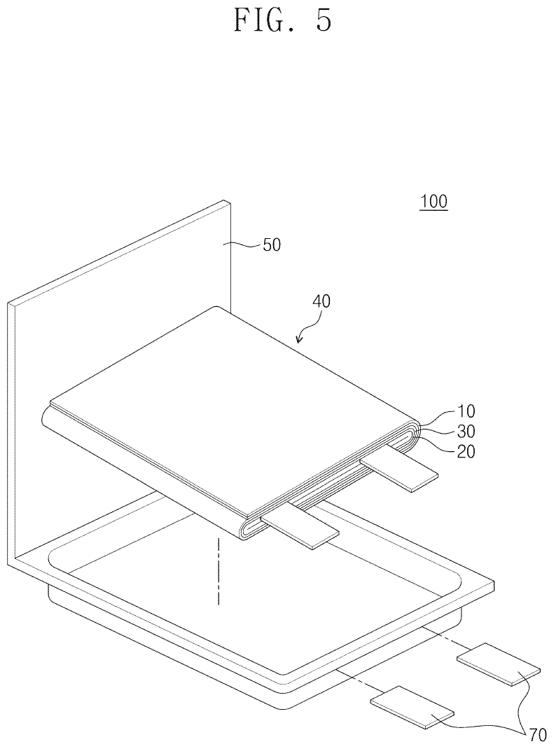

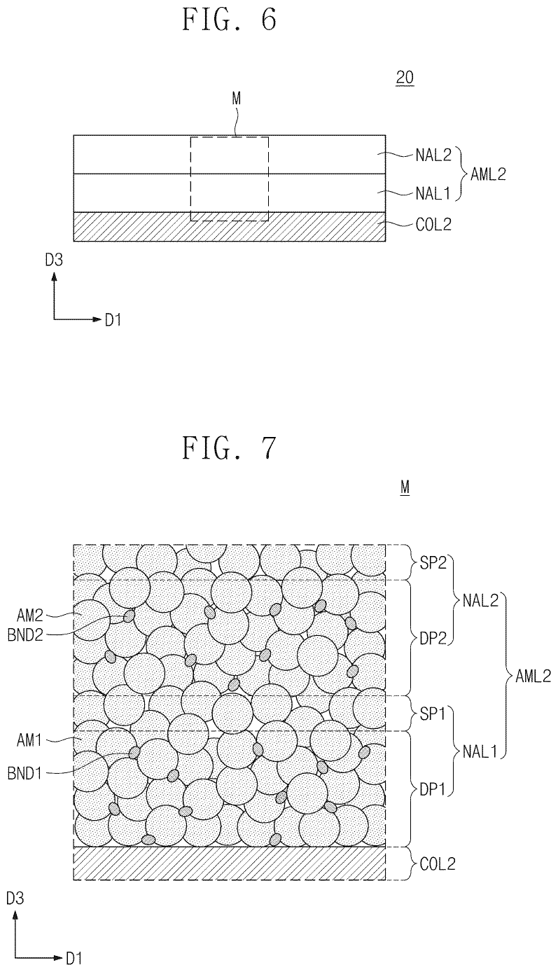

The negative electrode active material layer AML2 according to an example embodiment of the present disclosure is described in more detail below with reference to FIG. 6 to FIG. 11.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, or Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x≤2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO2, a Sn-based alloy, or a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer on a surface of the core.

The Si-based negative electrode active material or the Sn-based negative electrode active material may be used in combination with a carbon-based negative electrode active material.

### Separator 30

Based on a type of the rechargeable lithium battery, the separator 30 may be between positive electrode 10 and the negative electrode 20. The separator 30 may include one or more of polyethylene, polypropylene, and polyvinylidene fluoride, and may have a multi-layered separator thereof such as at least one of a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one surface, or on opposite surfaces, of the porous substrate, the coating layer including an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolane.

The non-aqueous organic solvent may be used alone, or in a mixture of two or more solvents.

For example, when a carbonate-based solvent is used, a cyclic carbonate and a chain carbonate may be mixed, and the cyclic carbonate and the chain carbonate may be mixed in a volume ratio in a range of about 1:1 to about 1:9.

The lithium salt may be or include a material that dissolves in the non-aqueous organic solvent to constitute a supply source of lithium ions in a battery and enables an operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers in a range of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), or lithium bis(oxalato)borate (LiBOB).

### Rechareable Lithium Battery

Based on the shape of the rechargeable lithium battery, the rechargeable lithium battery may be classified into cylindrical, prismatic, pouch, and coin types. FIG. 2 to FIG. 5 illustrate simplified diagrams showing a rechargeable lithium battery according to an example embodiment, with FIG. 2 showing a cylindrical battery, FIG. 3 showing a prismatic battery, and FIG. 4 and FIG. 5 showing pouch-type batteries. Referring to FIG. 2 to FIG. 5, the rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50, as illustrated in FIG. 2. In addition, as illustrated in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 may include an electrode tab 70, or a positive electrode tab 71 and a negative electrode tab 72, the electrode tabs 70/71/72 forming an electrical path for externally inducing a current generated in the electrode assembly 40.

The rechargeable lithium battery according to an example embodiment of the present disclosure may be applicable to, e.g., automotive vehicles, mobile phones, and/or any other electrical devices, but the present disclosure is not limited thereto.

Hereinafter, a negative electrode for a rechargeable lithium battery according to an example embodiment of the present disclosure is described in more detail.

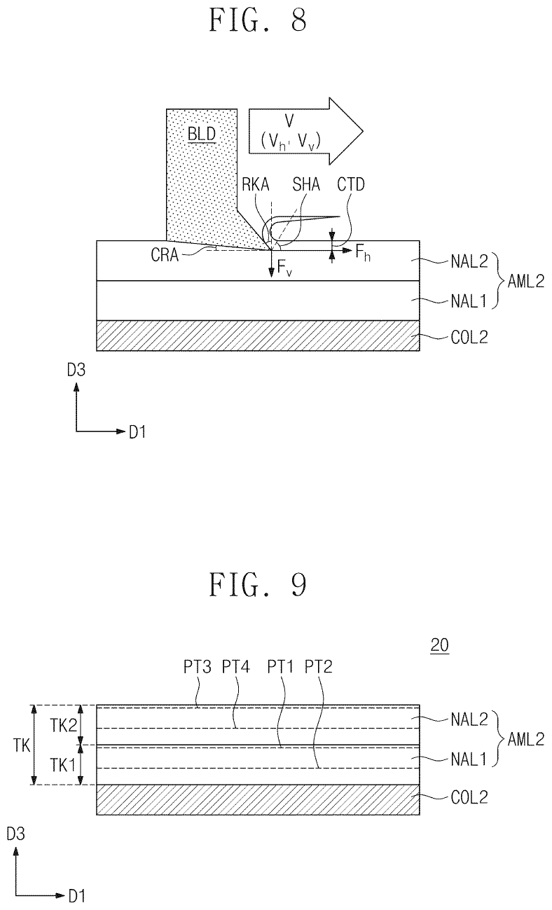

FIG. 6 is a cross-sectional view of a negative electrode for a rechargeable lithium battery, according to example embodiments of the present disclosure. FIG. 7 is a cross-sectional view illustrating a negative electrode for a rechargeable lithium battery according to an example embodiment of the present disclosure, in which a region “M” of FIG. 6 is enlarged. FIG. 8 is a diagram schematically illustrating a process of cutting a negative electrode active material layer using a Surface and Interfacial Cutting Analysis System (SAICAS). FIG. 9 is a diagram describing a negative electrode for a rechargeable lithium battery according to an example embodiment of the present disclosure.

Referring to FIG. 6, a negative electrode 20 for a rechargeable lithium battery according to example embodiments of the present disclosure may include a negative electrode current collector COL2 and a negative electrode active material layer AML2 on the negative electrode current collector COL2.

The negative electrode current collector COL2 may include at least one of copper foil, nickel foil, stainless-steel foil, titanium foil, nickel foam, copper foam, a polymer substrate coated with a conductive metal, or a combination thereof.

A thickness of the negative electrode current collector COL2 may be in a range of about 1 μm to about 20 μm. For example, the thickness of the negative electrode current collector COL2 may be in a range of about 5 μm to about 15 μm, about 7 μm to about 10 μm, or about 8 μm to about 10 μm.

### Negative Electrode Active Material Laver AML2

The negative electrode active material layer AML2 according to an example embodiment of the present disclosure may have a double layer structure. The negative electrode active material layer AML2 may include a first negative electrode active material layer NAL1 on the negative electrode current collector COL2, and a second negative electrode active material layer NAL2 on the first negative electrode active material layer NAL1. The first and second negative electrode active material layers NAL1 and NAL2 may be stacked, e.g., sequentially stacked, on the negative electrode current collector COL2. The first and second negative electrode active material layers NAL1 and NAL2 may be adjacent to each other in a third direction D3. The first and second negative electrode active material layers NAL1 and NAL2 may extend on the negative electrode current collector COL2 in a first direction D1.

In examples of the present disclosure, the first direction D1 may refer to any in-plane direction of the negative electrode (e.g., length direction or width direction). The third direction D3 may refer to a thickness direction perpendicular to the first direction D1.

Referring to FIG. 7, the negative electrode active material layer AML2 may include a negative electrode active material and a binder, and may further include a conductive material. The first negative electrode active material layer NAL1 may include a first negative electrode active material AM1 and a first binder BND1. The second negative electrode active material layer NAL2 may include a second negative electrode active material AM2 and a second binder BND2.

For example, the first and second negative electrode active material layers NAL1 and NAL2 may have the same composition as each other. The first and second negative electrode active material layers NAL1 and NAL2 may include the same negative electrode active material. The first and second negative electrode active materials AM1 and AM2 may be the same material. The first and second negative electrode active material layers NAL1 and NAL2 may include the same binder. The first and second binders BND1 and BND2 may be the same binder.

As another example, the first and second negative electrode active material layers NAL1 and NAL2 may have different compositions. The first and second negative electrode active material layers NAL1 and NAL2 may include different negative electrode active materials. The first and second negative electrode active materials AM1 and AM2 may be different from each other. The first and second negative electrode active material layers NAL1 and NAL2 may include different binders. The first and second binders BND1 and BND2 may be different from each other.

Each of, or at least one of, the first and second negative electrode active materials AM1 and AM2 may include at least one of a carbon-based negative electrode active material, a Si-based negative electrode active material, a Sn-based negative electrode active material, or a combination thereof. A detailed description thereof may be the same as the description above with reference to FIG. 1. For example, each of, or at least one of, the first and second negative electrode active materials AM1 and AM2 may include the carbon-based negative electrode active material.

Each of, or at least one of, the first and second binders BND1 and BND2 may include at least one of a non-aqueous binder, an aqueous binder, a dry binder, or a combination thereof. A detailed description thereof may be the same as the description above with reference to FIG. 1.

For example, each of, or at least one of, the first and second binders BND1 and BND2 may include at least one of styrene-butadiene rubber, (meth)acrylated styrene-butadiene rubber, a (meth)acrylonitrile-butadiene rubber, (meth)acrylic rubber, butyl rubber, fluoro elastomer, polyethylene oxide, polyvinylpyrrolidone, polyepichlorohydrin, polyphosphazene, poly(meth)acrylonitrile, ethylenepropylenediene copolymer, polyvinyl pyridine, chlorosulfonated polyethylene, latex, polyester resin, (meth)acrylic resin, phenolic resin, epoxy resin, or a combination thereof. For example, each of, or at least one of, the first and second binders BND1 and BND2 may be or include a rubber-based binder such as or including at least one of a styrene-butadiene rubber, a (meth)acrylated styrene-butadiene rubber, (meth)acrylonitrile-butadiene rubber, (meth) acrylic rubber, butyl rubber, or fluoro elastomer.

Each of, or at least one of, the first and second binders BND1 and BND2 may further include a thickener capable of imparting viscosity in a negative electrode slurry. For example, each of, or at least one of, the first and second binders BND1 and BND2 may further include a cellulose-based compound described with reference to FIG. 1.

Based on a total weight of the binder included in the negative electrode active material layer AML2, a weight ratio of the first binder BND1 included in the first negative electrode active material layer NAL1 may be greater than the weight ratio of the second binder BND2 included in the second negative electrode active material layer NAL2. Since a relatively greater amount of the binder is included in the first negative electrode active material layer NAL1 than in the second negative electrode active material layer NAL2, adhesion between the negative electrode current collector COL2 and the negative electrode active material layer AML2 may be improved.

For example, a weight ratio of the first binder BND1 to the second binder BND2 may be in a range of about 60:40 to about 90:10, or about 70:30 to about 90:10, based on the total weight of the first and second binders BND1 and BND2. In other words, the amount of the first binder BND1 included in the first negative electrode active material layer NAL1 may be in a range of about 60 wt % to about 90 wt %, and the amount of the second binder BND2 included in the second negative electrode active material layer NAL2 may be in a range of about 10 wt % to about 40 wt %, relative to the total weight of the binders included in the first and second negative electrode active material layers NAL1 and NAL2.

The first and second negative electrode active material layers NAL1 and NAL2 may have different binder amounts. For example, an amount of the first binder BND1 in the first negative electrode active material layer NAL1 may be greater than the amount of the second binder BND2 in the second negative electrode active material layer NAL2.

The first negative electrode active material layer NAL1 may include a first surface portion SP1 adjacent to a surface of the first negative electrode active material layer NAL1 (i.e., the other surface of the second negative electrode active material layer NAL2), and a first deep portion DP1 between the first surface portion SP1 and the negative electrode current collector COL2. The first negative electrode active material layer NAL1 may have a form in which the first binder BND1 in the first surface portion SP1 is at least partially removed by a surface treatment process described below.

The second negative electrode active material layer NAL2 may include a second surface portion SP2 adjacent to a surface of the second negative electrode active material layer NAL2, and a second deep portion DP2 between the second surface portion SP2 and the first negative electrode active material layer NAL1. The second negative electrode active material layer NAL2 may have a form in which the second binder BND2 in the second surface portion SP2 is at least partially removed by a surface treatment process described below.

In examples of the present disclosure, the first surface portion SP1 may refer to a region extending from the surface of the first negative electrode active material layer NAL1 toward the negative electrode current collector COL2 up to a depth in a range of about 10% to about 30% of a thickness of the first negative electrode active material layer NAL1. In examples of the present disclosure, the first deep portion DP1 may refer to a remaining region of the first negative electrode active material layer NAL1 excluding the first surface portion SP1. The first surface portion SP1 and the first deep portion DP1 may be adjacent to each other in the third direction D3. For example, the first surface portion SP1 may correspond to about 25% of the thickness of the first negative electrode active material layer NAL1. The first deep portion DP1 may correspond to about 75% of the thickness of the first negative electrode active material layer NAL1.

In examples of the present disclosure, the second surface portion SP2 may refer to a region extending from the surface of the second negative electrode active material layer NAL2 toward the negative electrode current collector COL2 up to a depth in a range of about 10% to about 30% of a thickness of the second negative electrode active material layer NAL2. In examples of the present disclosure, the second deep portion DP2 may refer to a remaining region of the second negative electrode active material layer NAL2 excluding the second surface portion SP2. The second surface portion SP2 and the second deep portion DP2 may be adjacent to each other in the third direction D3. For example, the second surface portion SP2 may correspond to about 25% of the thickness of the second negative electrode active material layer NAL2. The second deep portion DP2 may correspond to about 75% of the thickness of the second negative electrode active material layer NAL2.

According to an example embodiment of the present disclosure, an amount of the first binder BND1 in the first surface portion SP1 may be less than the amount of the first binder BND1 in the first deep portion DP1. A porosity of the first surface portion SP1 may be greater than the porosity of the first deep portion DP1. A mixture density of the first surface portion SP1 may be less than the mixture density of the first deep portion DP1. This may be due to the fact that the removal of the binder from the first surface portion SP1 causes the particles to rearrange, or the spacing between the particles to increase, thereby increasing internal voids and the thickness of the first surface portion SP1.

According to an example embodiment of the present disclosure, an amount of the second binder BND2 in the second surface portion SP2 may be less than the amount of the second binder BND2in the second deep portion DP2. A porosity of the second surface portion SP2 may be greater than the porosity of the second deep portion DP2. A mixture density of the second surface portion SP2 may be less than the mixture density of the second deep portion DP2. This may be due to the fact that the removal of the binder from the second surface portion SP2 causes the particles to rearrange, or the spacing between the particles to increase, thereby increasing internal voids and the thickness of the second surface portion SP2.

In examples of the present disclosure, the term “amount of binder” may refer to the weight ratio of the binder to the total weight of the negative electrode active material layer AML2. For example, the amount of the binder in the surface portion may refer to a weight ratio of the binder to the total weight of the surface portion. The amount of the binder in the deep portion may refer to a weight ratio of the binder to the total weight of the deep portion.

In examples of the present disclosure, the term “porosity” may refer to a ratio of the pore volume to the total volume of the negative electrode active material layer AML2. The unit of porosity is vol %, and may be used interchangeably with terms such as pore fraction and void fraction. A method for measuring a porosity is not particularly limited as long as the measurement method is known in the art. For example, porosity may be measured using Brunauer-Emmett-Teller (BET) method, or mercury permeation method (Hg porosimeter), or in accordance with ASTM D-2873. As another example, porosity may be measured using Focus Ion Beam-Scanning Electron Microscopy (FIB-SEM).

In examples of the present disclosure, the term “mixture density” may refer to a mass per unit volume of the negative electrode material (e.g., the negative electrode active material, the binder, the conductive material, and the like), and may be calculated by dividing the weight of the negative electrode active material layer AML2 excluding the negative electrode current collector COL2 by the volume thereof. A higher mixture density may indicate that a greater amount of the negative electrode material is included within the same volume of the negative electrode active material layer AML2.

According to an example embodiment of the present disclosure, each of, or at least one of, the first and second negative electrode active material layers NAL1 and NAL2 may have different binder amounts in each region along the thickness direction. In contrast, other components such as the negative electrode active material and the conductive material may be uniformly, or substantially uniformly, distributed within the negative electrode active material layer AML2. Therefore, the fast charging characteristics of the battery may be further improved by lowering the mixture density due to decreased binder amount, while the capacity per volume may not be significantly reduced. As a result, the rechargeable lithium battery including the negative electrode according to an example embodiment of the present disclosure may exhibit a high energy density and improved fast charging characteristics.

The adhesion characteristics of the first and second negative electrode active material layers NAL1 and NAL2 may be analyzed by a Surface and Interfacial Cutting Analysis System (SAICAS). The SAICAS may include an equipment that performs inclined cutting of a coated thin film sample from a surface to an interface by using a blade, and may measure a binding force applied to the blade during a cutting process. A detailed description of a measurement method using the SAICAS is described below with reference to FIG. 8.

Referring to FIG. 8, the blade BLD may cut the negative electrode active material layer AML2 from the surface thereof to the negative electrode current collector COL2 at a specific or desired cutting angle. During the cutting process, the horizontal binding force (Fₕ) and the vertical binding force (Fᵥ) applied to the blade BLD according to a cutting depth CTD may be measured. The surface of the negative electrode active material layer AML2 may be the surface adjacent to the separator 30 illustrated in FIG. 1. When cutting is performed at a specific or desired cutting angle, the blade BLD may be cut diagonally downward in the depth direction of the negative electrode active material layer AML2. The cutting may be performed until the blade BLD reaches the current collector COL2.

The blade BLD is not particularly limited as long as the blade BLD has a hardness that is greater than a hardness of the negative electrode active material layer AML2, and does not deform during the cutting process. For example, the material of the blade BLD may be made of or include a material such as diamond, cubic boron nitride (BN), steel, cermet, or ceramic.

A width of the blade BLD may be in a range of, for example, about 0.1 mm to about 4 mm, about 0.5 mm to about 2 mm, or about 0.7 mm to about 1.2 mm.

The clearance angle CRA may be greater than about 0° and less than or equal to about 15°. For example, the clearance angle CRA may be in a range of about 1° to about 15°, about 5° to about 13°, or about 7° to about 12°.

The rake angle RKA may be greater than about 0° and less than or equal to about 30°. For example, the rake angle RKA may be in a range of about 5° to about 30°, about 100 to about 30°, or about 150 to about 25°.

The shear angle SHA may be about 300 to about 50°. For example, the shear angle SHA may be in a range of about 350 to about 50°, or about 350 to about 45°.

An advancing speed of the blade BLD during the cutting of the negative electrode active material layer AML2 may be defined by a horizontal speed Vₕ and a vertical speed Vᵥ. For example, the horizontal velocity Vₕ may be in a range of about 1 μm/s to about 20 μm/s, about 5 μm/s to about 15 μm/s, or about 7 μm/s to about 12 μm/s. For example, the vertical velocity V, may be in a range of about 0.1 μm/s to about 5 μm/s, about 0.5 μm/s to about 3 μm/s, or about 0.5 μm/s to about 2 μm/s.

When each of the clearance angle CRA, the rake angle RCA, the shear angle SHA, the horizontal velocity Vₕ, and the vertical velocity Vᵥ satisfies the above-described ranges, the measurement time may be shortened, and the accuracy of the results may be improved.

According to an example embodiment of the present disclosure, the horizontal force Fₕ applied to the blade BLD according to the cutting depth CTD may be measured while performing the inclined cutting of the negative electrode active material layer AML2 using the SAICAS. The horizontal binding force Fₕ applied to the blade BLD may refer to a cohesion force. The horizontal binding force Fₕ may vary according to the cutting depth CTD. That is, the binder concentration profile by depth of the negative electrode active material layer AML2 may be inferred based on the horizontal binding force Fₕ measured according to the cutting depth CTD.

Referring to FIG. 9, the first negative electrode active material layer NAL1 may have a first thickness TK1. The second negative electrode active material layer NAL2 may have a second thickness TK2. A ratio TK2/TK1 of the second thickness TK2 to the first thickness TK1 may be in a range of about 0.8 to about 1.2. For example, the ratio TK2/TK1 of the second thickness TK2 to the first thickness TK1 may be equal to about 1.

The first negative electrode active material layer NAL1 may include one surface, and the other surface opposing the one surface and in contact with the negative electrode current collector COL2. The second negative electrode active material layer NAL2 may include one surface, and the other surface opposing the one surface and in contact with the first negative electrode active material layers NAL1.

The first negative electrode active material layer NAL1 may have a first point PT1 adjacent to the surface of the first negative electrode active material layer NAL1 (i.e., the other surface of the second negative electrode active material layer NAL2), and a second point PT2 located at a center portion of the first negative electrode active material layer NAL1. The second negative electrode active material layer NAL2 may have a third point PT3 adjacent to the surface of the second negative electrode active material layer NAL2, and a fourth point PT4 located at the center portion of the second negative electrodes active material layer NAL2.

When the negative electrode active material layer is measured by the SAICAS, a first horizontal binding force (Fₕ₁) may be provided at the first point PT1. A second horizontal binding force (Fₕ₂) may be provided at the second point PT2. A third horizontal binding force (Fₕ₃) may be provided at the third point PT3. A fourth horizontal binding force (Fₕ₄) may be provided at the fourth point PT4. The SAICAS measurement method is as described above with reference to FIG. 8.

According to an example embodiment of the present disclosure, when the negative electrode active material layer is measured by the SAICAS, at least one of the following conditions is satisfied: the first horizontal binding force (Fₕ₁) at the first point PT1 is less than or equal to the second horizontal binding force (Fₕ₂) at the second point PT2; the third horizontal binding force (Fₕ₃) at the third point PT3 is less than or equal to the fourth horizontal binding force (Fₕ₄) at the fourth point PT4; or the first horizontal binding force (Fₕ₁) is less than or equal to the second horizontal binding force (Fₕ₂), and the third horizontal binding force (Fₕ₃) is less than or equal to the fourth horizontal binding force (Fₕ₄).

With reference to FIG. 7, the first point PT1 may be located at the first surface portion SP1, and the second point PT2 may be located at the first deep portion DP1.

For example, a ratio of a distance from the surface of the first negative electrode active material layer NAL1 (i.e., the other surface of the second negative electrode active material layer NAL2) to the first point PT1 relative to the first thickness TK1 of the first negative electrode active material layer NAL1 may be about 25%. A ratio of a distance from the surface of the first negative electrode active material layer NAL1 to the second point PT2 relative to the first thickness TK1 of the first negative electrode active material layer NAL1 may be about 50%.

With reference to FIG. 7, the third point PT3 may be located at the second surface portion SP2, and the fourth point PT4 may be located at the second deep portion DP2.

For example, a ratio of a distance from the surface of the second negative electrode active material layer NAL2 to the third point PT3 relative to the second thickness TK2 of the second negative electrode active material layer NAL2 may be about 25%. A ratio of a distance from the surface of the second negative electrode active material layer NAL2 to the fourth point PT4 relative to the second thickness TK2 of the second negative electrode active material layer NAL2 may be about 50%.

Referring again to FIG. 7, in an example embodiment of the present disclosure, the binder amount may differ in specific or given regions along the thickness direction within the first negative electrode active material layer NAL1. Accordingly, the horizontal binding force Fₕ measured by the SAICAS at the first surface portion SP1 of the first negative electrode active material layer NAL1 may differ from the horizontal binding force Fₕ measured at the first deep portion DP1. For example, the horizontal binding force Fₕ applied to the blade BLD may be greater at the first deep portion DP1 than at the first surface portion SP1.

For example, the binder amount may differ in specific or given regions along the thickness direction within the second negative electrode active material layer NAL2. Accordingly, the horizontal binding force Fₕ measured by the SAICAS at the second surface portion SP2 of the second negative electrode active material layer NAL2 may differ from the horizontal binding force Fₕ measured at the second deep portion DP2. For example, the horizontal binding force Fₕ applied to the blade BLD may be greater at the second deep portion DP2 than at the second surface portion SP2.

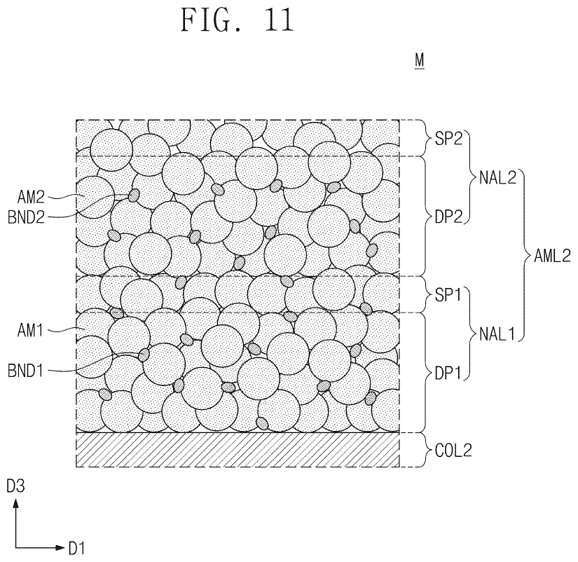

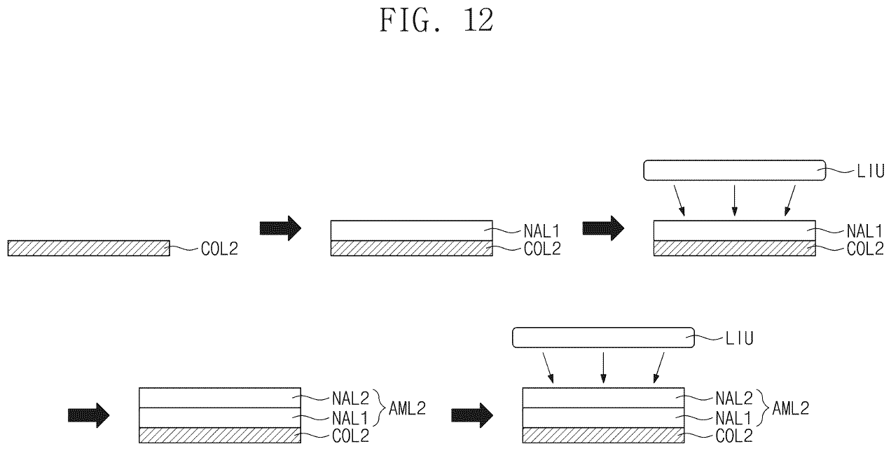

The negative electrode according to the example embodiment may be manufactured by a method described below with reference to FIG. 12.

According to an example embodiment of the present disclosure, in the first negative electrode active material layer NAL1, the first horizontal binding force (Fₕ₁) at the first point PT1 may be less than or equal to the second horizontal binding force (Fₕ₂) at the second point PT2. For example, in the second negative electrode active material layer NAL2, the third horizontal binding force (Fₕ₃) at the third point PT3 may be less than or equal to the fourth horizontal binding force (Fₕ₄) at the fourth point PT4.

A ratio of the second horizontal binding force (Fₕ₂) to the first horizontal binding force (Fₕ₁) may be in a range of about 100% to about 150%. For example, the ratio of the second horizontal binding force (Fₕ₂) to the first horizontal binding force (Fₕ₁) may be in a range of about 100% to about 130%, about 100% to about 120%, about 100% to about 115%, or about 100% to about 110%. In addition, a ratio of the fourth horizontal binding force (Fₕ₄) to the third horizontal binding force (Fₕ₃) may be in a range of about 100% to about 150%. For example, the ratio of the fourth horizontal binding force (Fₕ₄) to the third horizontal binding force (Fₕ₃) may be in a range of about 100% to about 130%, about 100% to about 120%, about 100% to about 115%, or about 100% to about 110%.

When each of the ratio of the second horizontal binding force (Fₕ₂) to the first horizontal binding force (Fₕ₁), and the ratio of the fourth horizontal binding force (Fₕ₄) to the third horizontal binding force (Fₕ₃) satisfies the above-described ranges, the migration resistance of lithium ions in the first and second negative electrode active material layers NAL1 and NAL2 may be reduced, thereby further improving fast charging characteristics. However, when each of, or any one of, the ratio of the second horizontal binding force (Fₕ₂) to the first horizontal binding force (Fₕ₁), and the ratio of the fourth horizontal binding force (Fₕ₄) to the third horizontal binding force (Fₕ₃), exceed the above-described ranges, excessive reduction in loading level caused by electrode delamination may lead to manufacturing issues.

According to an example embodiment of the present disclosure, the binder amount may differ in specific or given regions within the first negative electrode active material layer NAL1, as a lower layer. In addition, the binder amount may differ in specific or given regions within the second negative electrode active material layer NAL2, as an upper layer. Inclusion of the negative electrode active material layer having the above-described characteristics may effectively reduce migration resistance of lithium ions. As a result, the rechargeable lithium battery including the negative electrode of the present disclosure may exhibit a high capacity and improved fast charging characteristics.

In the following example embodiments of the present disclosure, detailed descriptions of technical features that overlap with the descriptions above with reference to FIG. 6 to FIG. 9 are omitted, and differences therewith are described in detail.

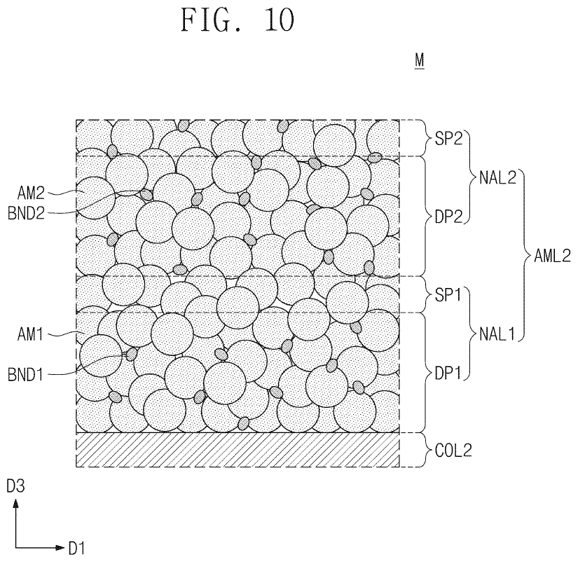

FIG. 10 and FIG. 11 are cross-section views illustrating a negative electrode for a rechargeable lithium battery, according to another example embodiment of the present disclosure, showing an enlarged view of region “M” in FIG. 6.

Referring to FIG. 10, in another example embodiment of the present disclosure, the binder amount may differ in specific or given regions along the thickness direction within the first negative electrode active material layer NAL1. Accordingly, the horizontal binding force Fₕ measured by the SAICAS at the first surface portion SP1 of the first negative electrode active material layer NAL1 may differ from the horizontal binding force Fₕ measured at the first deep portion DPL. For example, the horizontal binding force Fₕ applied to the blade may be greater at the first deep portion DP1 than at the first surface portion SP1.

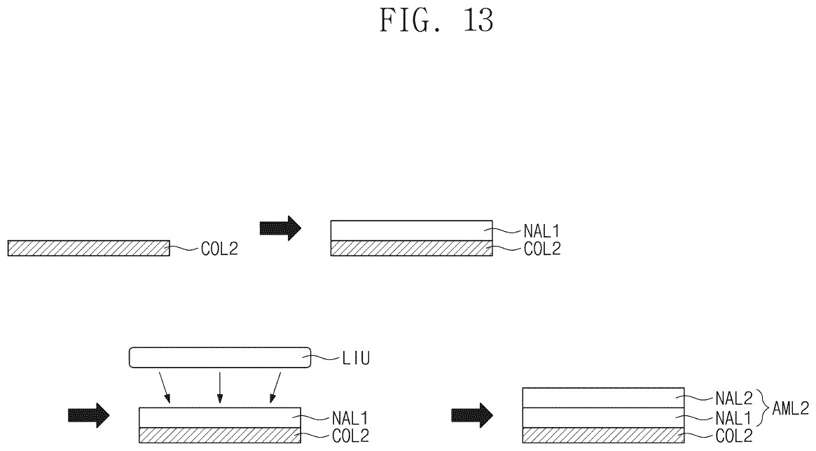

The negative electrode according to the example embodiment may be manufactured by a method described below with reference to FIG. 13.

According to the example embodiment, in the first negative electrode active material layer NAL1, the first horizontal binding force (Fₕ₁) at the first point PT1 may be less than or equal to the second horizontal binding force (Fₕ₂) at the second point PT2 (see FIG. 8 and FIG. 9).

A ratio of the second horizontal binding force (Fₕ₂) to the first horizontal binding force (Fₕ₁) may be in a range of about 100% to about 150%. For example, the ratio of the second horizontal binding force (Fₕ₂) to the first horizontal binding force (Fₕ₁) may be in a range of about 100% to about 130%, about 100% to about 120%, about 100% to about 115%, or about 100% to about 110%.

When the ratio of the second horizontal binding force (Fₕ₂) to the first horizontal binding force (Fₕ₁) satisfies the above-described range, migration resistance of lithium ions within the first negative electrode active material layer NAL1 may be improved, thereby enhancing fast charging characteristics of the battery. When the ratio of the second horizontal binding force (Fₕ₂) to the first horizontal binding force (Fₕ₁) exceeds the above-described range, excessive reduction in loading level caused by electrode delamination may lead to manufacturing issues.

According to the example embodiment, the surface treatment process may be performed only on the first negative electrode active material layer NAL1. By the surface treatment process performed on the first negative electrode active material layer NAL1, an amount of the first binder BND1 in the first surface portion SP1 may be less than the amount of the first binder BND1 in the first deep portion DP1. A porosity of the first surface portion SP1 may be greater than the porosity of the first deep portion DP1. A mixture density of the first surface portion SP1 may be less than the mixture density of the first deep portion DP1.

When the binder in the first surface portion SP1 of the first negative electrode active material layer NAL1 is removed, the negative electrode active material layer may exhibit improved mechanical strength (e.g., structural stability) compared to the case where the binder is removed from both the first surface portion SP1 of the first negative electrode active material layer NAL1 and the second surface portion SP2 of the second negative electrode active material layer NAL2, as described above. However, fast charging characteristics may be somewhat degraded due to the non-uniform lithium ion mobility between the first and second negative electrode active material layers NAL1 and NAL2.

The binder amount in the second negative electrode active material layer NAL2 may be substantially uniform. In another example embodiment, the binder amount in an upper portion of the second negative electrode active material layer NAL2 may be greater than the binder amount in a lower portion thereof. In this case, the third horizontal binding force (Fₕ₃) may be greater than the fourth horizontal binding force (Fₕ₄). For example, a ratio of the fourth horizontal binding force (Fₕ₄) to the third horizontal binding force (Fₕ₃) may be less than about 100%.

Referring to FIG. 11, in another example embodiment of the present disclosure, the binder amount may differ in specific regions along the thickness direction within the second negative electrode active material layer NAL2. Accordingly, the horizontal binding force (Fₕ) measured by the SAICAS at the second surface portion SP2 of the second negative electrode active material layer NAL2 may differ from the horizontal binding force (Fₕ) measured at the second deep portion DP2. For example, the horizontal binding force (Fₕ) applied to the blade may be greater at the second deep portion DP2 than at the second surface portion SP2.

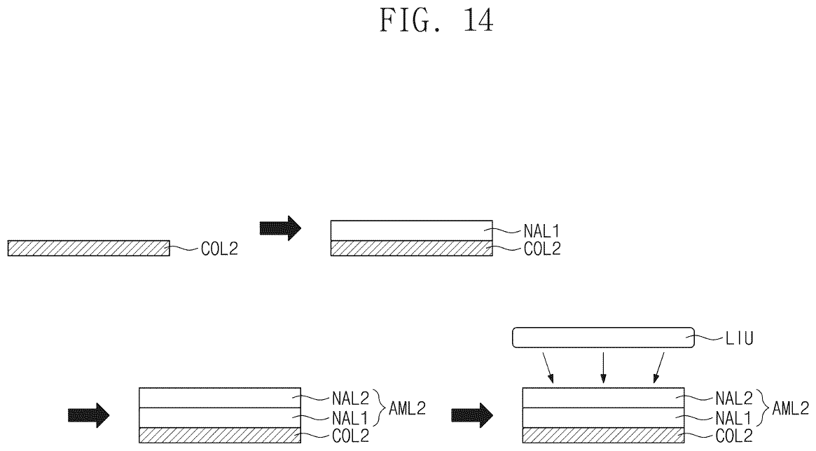

The negative electrode according to the example embodiment may be manufactured by a method described below with reference to FIG. 14.

According to the example embodiment, in the second negative electrode active material layer NAL2, the third horizontal binding force (Fₕ₃) at the third point PT3 may be less than or equal to the fourth horizontal binding force (Fₕ₄) at the fourth point PT4 (see FIGS. 8 and 9).

A ratio of the fourth horizontal binding force (Fₕ₄) to the third horizontal binding force (Fₕ₃) may be in a range of about 100% to about 150%. For example, the ratio of the fourth horizontal binding force (Fₕ₄) to the third horizontal binding force (Fₕ₃) may be in a range of about 100% to about 130%, about 100% to about 120%, about 100% to about 115%, or about 100% to about 110%.

When the ratio of the fourth horizontal binding force (Fₕ₄) to the third horizontal binding force (Fₕ₃) satisfies the above-described range, migration resistance of lithium ions within the second negative electrode active material layer NAL2 may be improved, thereby enhancing fast charging characteristics of the battery. When the ratio of the fourth horizontal binding force (Fₕ₄) to the third horizontal binding force (Fₕ₃) exceeds the above-described range, excessive reduction in loading level caused by electrode delamination may lead to manufacturing issues.

According to the example embodiment, the surface treatment process may be performed only on the second negative electrode active material layer NAL2. By the surface treatment process performed on the second negative electrode active material layer NAL2, an amount of the second binder BND2 in the second surface portion SP2 may be less than the amount of the second binder BND2 in the second deep portion DP2. A porosity of the second surface portion SP2 may be greater than the porosity of the second deep portion DP2. A mixture density of the second surface portion SP2 may be less than the mixture density of the second deep portion DP2.

When the binder in the second surface portion SP2 of the second negative electrode active material layer NAL2 is removed, the negative electrode active material layer may exhibit improved mechanical strength (e.g., structural stability) compared to the case where the binder is removed from both the first surface portion SP1 of the first negative electrode active material layer NAL1 and the second surface portion SP2 of the second negative electrode active material layer NAL2, as described above. However, fast charging characteristics may be somewhat degraded due to the non-uniform lithium ion mobility between the first and second negative electrode active material layers NAL1 and NAL2.

The binder amount in the first negative electrode active material layer NAL1 may be substantially uniform. In another example embodiment, the binder amount in upper portion of the first negative electrode active material layer NAL1 may be greater than the binder amount in the lower portion. In this case, the first horizontal binding force (Fₕ₁) may be greater than the second horizontal binding force (Fₕ₂). For example, a ratio of the second horizontal binding force (Fₕ₂) to the first horizontal binding force (Fₕ₁) may be less than about 100%.

### Method for Manufacturing Negative Electrode

A method for manufacturing a negative electrode for a rechargeable lithium battery according to an example embodiment of the present disclosure may include preparing a negative electrode current collector, forming a first negative electrode active material layer on the negative electrode current collector, forming a second negative electrode active material layer on the first negative electrode active material layer, and performing a surface treatment process on at least one of the first negative electrode active material layer, the second negative electrode active material layer, or both, to remove a binder in a surface portion.

FIG. 12 is a diagram for explaining a method for manufacturing a negative electrode for a rechargeable lithium battery according to an example embodiment of the present disclosure.

Referring to FIG. 12, in an example embodiment of the present disclosure, a first surface treatment process and a second surface treatment process may be performed on a first negative electrode active material layer NAL2 and a second negative electrode active material layer NAL2, respectively. Thus, the first negative electrode active material layer NAL1 may have a form in which a binder in a surface portion is partially removed through the first surface treatment process. The second negative electrode active material layer NAL2 may have a form in which a binder in a surface portion is partially removed through the second surface treatment process (see FIG. 7).

For example, after forming the first negative electrode active material layer NAL1 on a negative electrode current collector COL2, the first surface treatment process may be performed on the first negative electrode active material layer NAL 1. Subsequently, after forming the second negative electrode active material layer NAL2 on the first negative electrode active material layer NAL1, the second surface treatment process may be performed on the second negative electrode active material layer NAL2.

First, the negative electrode current collector COL2 may be prepared. For example, the negative electrode current collector COL2 may include at least one of a copper foil, a nickel foil, a stainless-steel foil, a titanium foil, a nickel foam, a copper foam, a polymer substrate coated with a conductive metal, or a combination thereof.

The first negative electrode active material layer NAL1 may be formed on the negative electrode current collector COL2. Forming the first negative electrode active material layer NAL1 may include applying a first negative electrode slurry onto the negative electrode current collector COL2, and drying the first negative electrode slurry.

The first negative electrode slurry may include a negative electrode active material and a binder. The first negative electrode slurry may further include a conductive material as necessary. In preparing the negative electrode slurry, the negative electrode active material and the binder are added to an organic solvent, and then stirred to prepare the negative electrode slurry.

The organic solvent may be or include a solvent commonly used in the art. For example, the organic solvent may include at least one of dimethyl sulfoxide (DMSO), isopropyl alcohol, N-methylpyrrolidone (NMP), acetone, water, or a combination thereof.

The first negative electrode slurry may be applied to at least one surface of the negative electrode current collector COL2 at a constant, or substantially constant, thickness. The applying method is not particularly limited, and coating equipment such as a doctor blade or a slot die coater may be used.

The first negative electrode slurry applied on the negative electrode current collector COL2 may be dried. The solvent included in the first negative electrode slurry may be removed through the drying process to form the first negative electrode active material layer NAL1. A rolling process may then be performed on the first negative electrode active material layer NAL1. In the example embodiment, although the rolling process is, for example, performed after the drying process of the first negative electrode active material layer NAL1, the present disclosure is not limited thereto. In another example embodiment, the rolling process may be omitted during the formation of the first negative electrode active material layer NAL1, and may be performed after the first surface treatment process and/or the second surface treatment process.

In general, during the drying process of the above-described first negative electrode slurry, a migration phenomenon may occur in which the binder moves to the surface due to solvent flow, resulting in an increased binder concentration in the surface portion of the first negative electrode active material layer NAL1. As a result, the internal resistance of the battery may increase, causing a significant decrease in fast charging characteristics.

According to an example embodiment of the present disclosure, the binder in the surface portion of the first negative electrode active material layer NAL1 may be removed by performing the first surface treatment process on the first negative electrode active material layer NAL1.

As described above, the first negative electrode active material layer NAL1 may include a first surface portion SP1 adjacent to the surface of the first negative electrode active material layer NAL1, and a first deep portion DP1 between the first surface portion SP1 and the negative electrode current collector COL2. A detailed description thereof is as described above with reference to FIG. 7.

Removing the binder in the surface portion of the first negative electrode active material layer NAL1 may include performing the first surface treatment process on the surface of the first negative electrode active material layer NAL1 to remove the binder in the first surface portion SP1. In examples of the present disclosure, removing the binder may indicate that the amount of the binder in the negative electrode active material layer is reduced to about 50% or less, for example, a range of about 20% to about 30%, as compared to before the surface treatment process is performed.

By the first surface treatment process performed on the first negative electrode active material layer NAL1, a mixture density of the first surface portion may be less than the mixture density of the first deep portion. An amount of binder in the first surface portion SP1 may be less than the amount of binder in the first deep portion DP1. A porosity of the first surface portion SP1 may be greater than the porosity of the first deep portion DP1. A detailed description of the surface treatment process is described below.

Next, the second negative electrode active material layer NAL2 may be formed on the first negative electrode active material layer NAL1. Forming the second negative electrode active material layer NAL2 may include applying the second negative electrode slurry onto the negative electrode current collector COL2, and then drying the second negative electrode slurry. The second negative electrode slurry may include a negative electrode active material and a binder. The second negative electrode slurry may further include a conductive material as necessary or desired. The second negative electrode slurry may be applied to at least one surface of the negative electrode current collector COL2 at a constant, or substantially constant, thickness. Then, the second negative electrode slurry applied on the first negative electrode active material layer NAL1 may be dried. The solvent included in the second negative electrode slurry may be removed through the drying process to form the second negative electrode active material layer NAL2. Then, a rolling process may be performed on the second negative electrode active material layer NAL2. In the example embodiment, although the rolling process is, for example, performed after the drying process of the second negative electrode active material layer NAL2, the present disclosure is not limited thereto. In another example embodiment, the rolling process may be omitted during the formation of the second negative electrode active material layer NAL2, and may be performed after the second surface treatment process.

In the drying process of the second negative electrode slurry, as described above, a migration phenomenon may occur in which the binder moves to the surface due to solvent flow, resulting in an increased binder concentration in the surface portion of the second negative electrode active material layer NAL2.

According to an example embodiment of the present disclosure, the binder in the surface portion of the second negative electrode active material layer NAL2 may be removed by performing the second surface treatment process on the second negative electrode active material layer NAL2.

As described above, the second negative electrode active material layer NAL2 may include a second surface portion SP2 adjacent to the surface of the second negative electrode active material layer NAL2, and a second deep portion DP2 between the second surface portion SP2 and the first negative electrode active material layer NAL1. A detailed description thereof is as described above with reference to FIG. 7.

Removing the binder in the surface portion of the second negative electrode active material layer NAL2 may include performing the second surface treatment process on the surface of the second negative electrode active material layer NAL2 to remove the binder in the second surface portion.

By the second surface treatment process performed on the second negative electrode active material layer NAL2, a mixture density of the second surface portion may be less than the mixture density of the second deep portion. An amount of binder in the second surface portion may be less than the amount of binder in the second deep portion. A porosity of the second surface portion may be greater than the porosity of the second deep portion.

The above-described surface treatment process may be continuously, or substantially continuously, performed by being applied to a process line for manufacturing the negative electrode. The surface treatment process may be performed by any one of a light irradiation, a heat treatment, or a plasma treatment, but is not particularly limited thereto as long as the method is known in the art. For example, the surface treatment process may be performed by light irradiation.

According to an example embodiment of the present disclosure, binder removal through the light irradiation may be performed by selectively thermally decomposing or oxidizing only the binder in the surface portion of the negative electrode active material layer AML2. Since the binder has a relatively low bonding energy and decomposition temperature, it may be possible to selectively remove only the binder through the light irradiation. In this case, other components (e.g., the negative electrode active material and/or the conductive material) may remain unaffected.

The light irradiation may be performed using a light irradiation unit LIU. For example, the light irradiation unit LLU may be a xenon flash lamp, but the present disclosure is not limited thereto.

For example, when the light irradiation is performed using the xenon flash lamp, chemical bonds within the binder (e.g., C—C, C═C, or C—H bonds) may be broken due to thermal decomposition or oxidation reactions of the binder. Thus, the binder may be decomposed into low molecular weight volatile compounds and evaporated, or oxidized to CO₂ or moisture and removed.

The light irradiation using a xenon flash lamp may include irradiating light having a broad spectrum of light including infrared rays, visible light, and ultraviolet rays at high intensity for a short period of time. The light emitted from the xenon flash lamp may have a wavelength range of about 200 nm to about 1500 nm. The light irradiation may include applying a voltage in a range of about 100V to about 1000V. For example, the applied voltage may be in a range of about 100V to about 800V, about 200V to about 800V, about 300V to about 700V, or about 300V to about 500V. The light irradiation may be performed for a duration in a range of about 100 μs to about 2000 μs. For example, the irradiation time may be in a range of about 100 μs to about 1500 μs, about 100 μs to about 1000 μs, about 100 μs to about 500 μs, or about 100 μs to about 400 μs. When light irradiation is performed under the above conditions, the binder in the surface portion of the negative electrode active material layer may be removed in a desired amount. As a result, the reduction in the mixture density of the negative electrode active material layer may improve lithium ion mobility, thereby improving or maximizing the enhancement in fast charging characteristics of the battery.

The method for manufacturing a negative electrode according to an example embodiment of the present disclosure may further include a post-treatment process after the surface treatment process. The post-treatment process may include removing carbonized residues generated during the thermal decomposition or oxidation of the binder by the light irradiation. For example, the post-treatment process may be performed by chemical cleaning, physical cleaning, or laser cleaning.

In the following example embodiments of the present disclosure, detailed descriptions of technical features that overlap with the method for manufacturing a negative electrode described above with reference to FIG. 12 is omitted, and differences therewith are described in detail.

FIG. 13 is a diagram explaining a method for manufacturing a negative electrode for a rechargeable lithium battery according to another example embodiment of the present disclosure.

Referring to FIG. 13, in another example embodiment of the present disclosure, the first surface treatment process may be performed only on the first negative electrode active material layer NAL1. Thus, the first negative electrode active material layer NAL1 may have a form in which the binder in the first surface portion is partially removed through the first surface treatment process (see FIG. 10).

By the first surface treatment process performed on the first negative electrode active material layer NAL1, the mixture density of the first surface portion SP1 may be less than the mixture density of the first deep portion DP1. The amount of the binder in the first surface portion SP1 may be less than the amount of the binder in the first deep portion DP1. The porosity of the first surface portion may be greater than the porosity of the first deep portion.

FIG. 14 is a diagram for explaining a method for manufacturing a negative electrode for a rechargeable lithium battery according to another example embodiment of the present disclosure.

Referring to FIG. 14, in another example embodiment of the present disclosure, the second surface treatment process may be performed only on the second negative electrode active material layer NAL2. Thus, the second negative electrode active material layer NAL2 may have a form in which the binder in the second surface portion is partially removed through the surface treatment process (see FIG. 11).

By the second surface treatment process performed on the second negative electrode active material layer NAL2, the mixture density of the second surface portion may be less than the mixture density of the second deep portion. The amount of binder in the second surface portion may be less than the amount of binder in the second deep portion. The porosity of the second surface portion SP2 may be greater than the porosity of the second deep portion DP2.

FIG. 16 is a flow chart illustrating a method of manufacturing a negative electrode, according to an example embodiment. In FIG. 16, the method 1600 includes operation 1610, which includes preparing a negative electrode current collector. Operation 1620 includes forming a first negative electrode active material layer on the negative electrode current collector. For example, the first negative electrode active material layer includes a first surface portion adjacent to a surface of the first negative electrode active material layer, and a first deep portion between the first surface portion and the negative electrode current collector.

Operation 1630 includes forming a second negative electrode active material layer on the first negative electrode active material layer. For example, the second negative electrode active material layer includes a second surface portion adjacent to one surface of the second negative electrode active material layer, and a second deep portion between the second surface portion and the first negative electrode active material layer.

Operation 1640 includes performing a surface treatment process on at least one of the first negative electrode active material layer and the second negative electrode active material layer to remove a binder in a surface portion. For example, removing the binder includes performing a first surface treatment process on the surface of the first negative electrode active material layer to remove the binder in the first surface portion, and a mixture density of the first surface portion is less than a mixture density of the first deep portion. In another example, removing the binder includes performing a second surface treatment process on the one surface of the second negative electrode active material layer to remove the binder in the second surface portion, and a mixture density of the second surface portion is less than a mixture density of the second deep portion. In an example, an amount of the binder in the first surface portion is less than an amount of the binder in the first deep portion, and a porosity of the first surface portion is greater than a porosity of the first deep portion. In another example, an amount of the binder in the second surface portion is less than the amount of the binder in the second deep portion, and a porosity of the second surface portion is greater than a porosity of the second deep portion. In an example, the surface treatment process is performed by a light irradiation using a flash lamp. For example, the light irradiation includes applying a voltage in a range of about 100 V to about 1000 V. In another example, the light irradiation is performed for a duration in a range of about 100 μs to about 2000 μs.

Hereinafter, examples of the present disclosure are described in more detail as follows. However, the examples shown below are provided to assist in the understanding of the present disclosure, and the scope of the present disclosure is not limited to the examples.

### Example 1

### Manufacture of Negative Electrode:

A first negative electrode slurry was prepared by mixing 96 wt % of natural graphite and 1.5 wt % of carboxymethyl cellulose, and 2.5 wt % of styrene-butadiene rubber in pure water.

A second negative electrode slurry was prepared by mixing 99 wt % of artificial graphite, 0.4 wt % of carboxymethyl cellulose, and 0.6 wt % of styrene-butadiene rubber in pure water.

The prepared first negative electrode slurry was applied onto a Cu current collector. After drying at 80 °C and performing a rolling process, a first negative electrode active material layer having a thickness of 40 μm was formed. A first light irradiation process was performed on a surface of the first negative electrode active material layer to remove the binder in a surface portion of the first negative electrode active material layer.

The prepared second negative electrode slurry was applied onto the surface of the first negative electrode active material layer on which the first light irradiation process was performed. After drying at 80 °C, and performing a rolling process, a second negative electrode active material layer having a thickness of about 40 μm was formed. A second light irradiation process was performed on a surface of the second negative electrode active material layer to remove the binder in a surface portion of the second negative electrode active material layer. The first and second light irradiation processes were performed using a Xenon Flash Lamp (Pulseforge Inc.) under the following conditions.
Irradiation time: 350 us
Applied voltage: 500 V

### Manufacture of Rechargeable Lithium Battery:

A positive electrode slurry was prepared by mixing 98.5 wt % of LiCoO₂, 1 wt % of polyvinylidenefluoride (PVdF), and 0.5 wt % of carbon black in N-methylpyrrolidone.

The prepared positive electrode slurry was applied onto an Al current collector, and then the slurry was dried and rolled to form a positive electrode active material layer having a total thickness of 90 μm.

The negative electrode, the positive electrode, and a polyethylene separator having a thickness of 10 μm were stacked to prepare an electrode assembly. The electrode assembly was placed in a case, and then an electrolyte was injected to manufacture a rechargeable lithium battery.

As the electrolyte, one in which 1.3 M LiPF₆ was dissolved in a mixed organic solvent of ethylene carbonate (EC), ethyl methyl carbonate (EMC), and diethyl carbonate (DEC) (3:5:2 by volume ratio) was used.

### Example 2

A negative electrode was manufactured in the same manner as in Example 1, with a difference that the second light irradiation process performed on the second negative electrode active material layer was omitted.

A rechargeable lithium battery was manufactured in the same manner as in Example 1, with a difference that the negative electrode was used.

### Example 3

A negative electrode was manufactured in the same manner as in Example 1, with a difference that the first light irradiation process performed on the first negative electrode active material layer was omitted.

A rechargeable lithium battery was manufactured in the same manner as in Example 1, with a difference that the negative electrode was used.

### Comparative Example 1

A negative electrode was produced in the same manner as in Example 1, with a difference that the first light irradiation process performed on the first negative electrode active material layer, and the second light irradiation process performed onto the second negative electrode active material layer were omitted.

A rechargeable lithium battery was manufactured in the same manner as in Example 1, with a difference that the negative electrode was used.

### Evaluation Example 1: SAICAS Analysis of Cathode

For the negative electrodes according to Examples 1 to 3 and Comparative Example 1, the binding characteristics of the negative electrode active material layer were analyzed using a Surface-Interface Cutting Analysis System (SAICAS EN-EX, Daipla Wintes, JAPAN). While performing the oblique cutting of the negative electrode active material layer, the horizontal binding force applied to the blade was measured according to the cutting depth. The measurement conditions are as follows.
Blade type: diamond
Blade width: 1 mm
Rake angle: 20 degrees
Shearing angle: 45 degrees
Clearance angle: 10 degrees
Horizontal velocity: 10 micrometers/second
Vertical velocity: 1 micrometers/second

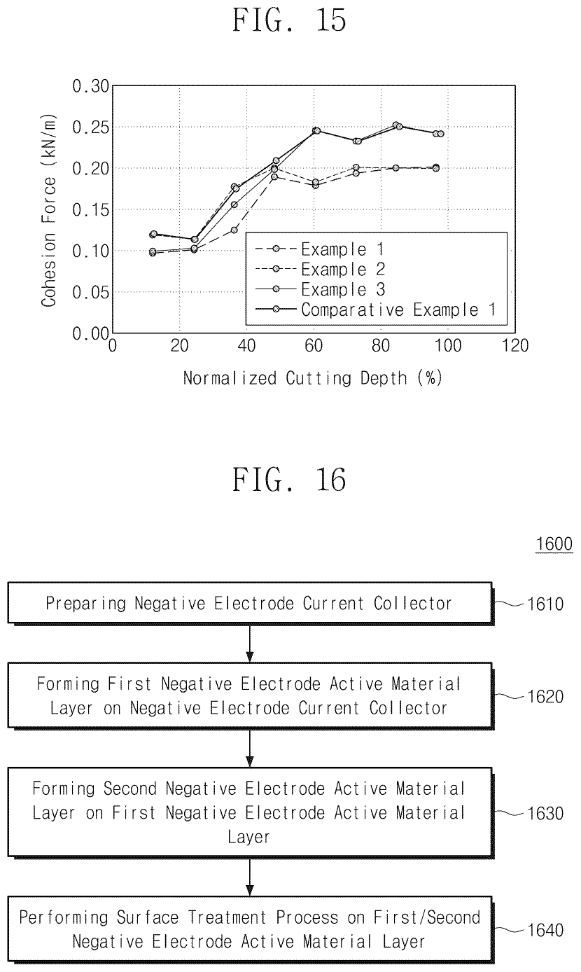

The measurement result is represented by a graph of the horizontal force (Fₕ) according to the cutting depth. The normalized cutting depth of the x-axis is represented by dividing the cutting depth by the total thickness of the negative electrode active material layer AML2. The cohesion force of the y-axis is represented by the horizontal force (Fₕ). The results are shown in FIG. 15.

A first horizontal binding force (Fₕ₁) was measured at a first point located at a distance of 25% of the thickness of the first negative electrode active material layer from the surface toward the negative electrode current collector. A second horizontal binding force (Fₕ₂) was measured at a second point located at a distance of 50% of the thickness of the first negative electrode active material layer from the surface toward the negative electrode current collector.

A third horizontal binding force (Fₕ₃) was measured at a third point located at a distance of 25% of the thickness of the second negative electrode active material layer from the surface toward the first negative electrode active material layer (or negative electrode current collector). A fourth horizontal binding force (Fₕ₄) was measured at a fourth point located at a distance of 50% of the thickness of the second negative electrode active material layer from the surface toward the first negative electrode active material layer.

A ratio of the second horizontal binding force (Fₕ₂) to the first horizontal binding force (Fₕ₁), and a ratio of the fourth horizontal binding force (Fₕ₄) to the third horizontal binding force (Fₕ₃), are calculated according to the following Equations 1 and 2, respectively, and are shown in Table 1 below.

A ratio of the second horizontal binding force (Fₕ₂) to the first horizontal binding force (Fₕ₁)=(Fₕ₂/Fₕ₁)×100. Equation 1:

A ratio of the fourth horizontal binding force (Fₕ₄) to the third horizontal binding force (Fₕ₃)=(Fₕ₄/Fₕ₃)×100 Equation 2:

TABLE 1

| | Horizontal binding force ratio (%) | |
|---|---|---|
| | First Negative Electrode | Second Negative Electrode |
| | Active Material Layer | Active Material Layer |
| Example 1 | 108.49 | 104.11 |
| Example 2 | 109.46 | 94.89 |
| Example 3 | 94.81 | 104.04 |
| Comparative | 94.65 | 94.84 |
| Example 1 | | |

Referring to Table 1, it can be seen that the ratio of the second horizontal binding force (Fₕ₂) to the first horizontal binding force (Fₕ₁) is relatively larger in the negative electrodes according to Examples 1 and 2, compared to the negative electrode according to Comparative Example 1. In addition, it can be seen that the ratio of the fourth horizontal binding force (Fₕ₄) to the third horizontal binding force (Fₕ₃) is relatively larger in the negative electrodes according to Examples 1 and 3, compared to the negative electrode according to Comparative Example 1.

Specifically, in the case of the negative electrode according to Example 1, it can be seen that in the first negative electrode active material layer, the first horizontal binding force (Fₕ₁) is smaller than the second horizontal binding force (Fₕ₂). In addition, it can be seen that in the second negative electrode active material layer, the third horizontal binding force (Fₕ₃) is less than the fourth horizontal binding force (Fₕ₄). From these results, it can be understood that the binder in each surface portion of the first and second negative electrode active material layers was removed by the light irradiation process performed thereon.

In the case of the negative electrode according to Example 2, it can be seen that in the first negative electrode active material layer, the first horizontal binding force (Fₕ₁) is smaller than the second horizontal binding force (Fₕ₂). From this result, it can be understood that the binder in the surface portion of the first negative electrode active material layer was removed by the light irradiation process performed thereon.

In addition, in the case of the negative electrode according to Example 3, it can be seen that in the second negative electrode active material layer, the third horizontal binding force (Fₕ₃) is smaller than the fourth horizontal binding force (Fₕ₄). From this result, it can be understood that the binder in the surface portion of the second negative electrode active material layer was removed by the light irradiation process performed thereon.

### Evaluation Example 2: Ionic Resistance Analysis of Negative Electrode

The ionic resistance (Rᵢₒₙ) of the negative electrodes according to Examples 1 to 3 and Comparative Example 1 was evaluated. The ionic resistance was measured by preparing a symmetric cell composed of two negative electrodes, and injecting an electrolyte. As the electrolyte, a solution was used in which 1.2 M LiPF₆ was dissolved in an organic solvent prepared by mixing ethylene carbonate (EC) and ethyl methyl carbonate (EMC) at a volume ratio of 3:7. Specifically, the ionic resistance was measured by electrochemical impedance spectroscopy (EIS) with VSP-300 Potentiostat (Bio-Logic Science Instruments SAS). The measurement was performed by applying an AC voltage of 10 mV in a frequency range of 1 Hz to 1 MHz. The results are shown in Table 2 below.

TABLE 2

| | Ion Resistance (Ω · cm²) |
|---|---|
| Example 1 | 17.9 |
| Example 2 | 19.2 |
| Example 3 | 18.9 |
| Comparative Example 1 | 22 |

Referring to Table 2, it can be confirmed that the negative electrodes according to Examples 1 to 3 exhibit relatively lower ionic resistance compared to the negative electrode according to Comparative Example 1.

### Evaluation Example 3: Charge Rate Characteristics Evaluation

The rechargeable lithium batteries according to Examples 1 to 3 and Comparative Example 1 were charged at a constant current of 0.2 C until the voltage reached 4.4 V, and were charged at a constant voltage while maintaining 4.4 V until the current reached 0.025 C. The batteries subjected to constant voltage charging was discharged at constant current of 0.2 C, 0.5 C, 0.7 C, and 1 C, until the voltage reached 2.75 V, and the charge capacity for each C-rate was measured. From the measured results, a ratio of the charge capacity at 1.0 C to the charge capacity at 0.2 C was calculated, and the results are shown as charge rate characteristics in Table 3 below.

TABLE 3

| | Charge Rate Characteristics |
|---|---|
| | (%, 1.0 C/0.2 C) |
| Example 1 | 83.2 |
| Example 2 | 81.2 |
| Example 3 | 81.5 |
| Comparative Example 1 | 79.5 |

Referring to Table 3, it can be confirmed that the rechargeable lithium batteries according to Examples 1 to 3 exhibit improved charge rate characteristics compared to the rechargeable lithium battery according to Comparative Example 1.

The negative electrode for the rechargeable lithium battery according to an example embodiment of the present disclosure may have a different binder amount in each of regions within an upper layer and/or a lower layer constituting the negative electrode active material layer. Accordingly, migration resistance of lithium ions within the negative electrode may be improved. As a result, the rechargeable lithium battery including the negative electrode of the present disclosure may exhibit high capacity and improved fast charging characteristics.

While the present disclosure has been described with reference to example embodiments, it should be understood that these example embodiments are provided for illustrative purposes only and do not limit the scope of the present disclosure. Various modifications and equivalent arrangements may be made without departing from the spirit and scope of the appended claims. Accordingly, the described embodiments should be regarded as examples rather than limitations of the present disclosure.

What is claimed is:

1. A negative electrode for a rechargeable lithium battery, the negative electrode comprising:
a negative electrode current collector;
a first negative electrode active material layer on the negative electrode current collector; and
a second negative electrode active material layer on a surface of the first negative electrode active material layer,
wherein the first negative electrode active material layer comprises a first binder,
wherein the second negative electrode active material layer comprises a second binder,
wherein the second negative electrode active material layer includes one surface, and an other surface opposite to the one surface, the other surface being in contact with the first negative electrode active material layer,
wherein the first negative electrode active material layer has a first point adjacent to the surface of the first negative electrode active material layer, and a second point located in a center portion of the first negative electrode active material layer,
wherein the second negative electrode active material layer has a third point adjacent to the one surface of the second negative electrode active material layer, and a fourth point located in a center portion of the second negative electrode active material layer, and
wherein at least one of:
a first horizontal binding force (Fₕ₁) at the first point is less than or equal to a second horizontal binding force (Fₕ₂) at the second point;
a third horizontal binding force (Fₕ₃) at the third point is less than or equal to a fourth horizontal binding force (Fₕ₄) at the fourth point; and
the first horizontal binding force is less than or equal to the second horizontal binding force, and the third horizontal binding force is less than or equal to a fourth horizontal binding force.

2. The negative electrode as claimed in claim 1, wherein a ratio of a distance from the surface of the first negative electrode active material layer to the first point relative to a thickness of the first negative electrode active material layer is about 25%,
wherein a ratio of a distance from the surface of the first negative electrode active material layer to the second point relative to the thickness of the first negative electrode active material layer is about 50%,
wherein a ratio of a distance from the one surface of the second negative electrode active material layer to the third point relative to a thickness of the second negative electrode active material layer is about 25%, and
wherein a ratio of a distance from the one surface of the second negative electrode active material layer to the fourth point relative to the thickness of the second negative electrode active material layer is about 50%.

3. The negative electrode as claimed in claim 1, wherein a ratio of the second horizontal force to the first horizontal force is in a range of about 100% to about 150%.

4. The negative electrode as claimed in claim 1, wherein a ratio of the fourth horizontal force to the third horizontal force is in a range of about 100% to about 150%.

5. The negative electrode as claimed in claim 1, wherein at least one of the first binder and the second binder comprises at least one of an aqueous binder, a non-aqueous binder, a dry binder, and a combination thereof.

6. The negative electrode as claimed in claim 1, wherein an amount of the first binder in the first negative electrode active material layer is greater than an amount of the second binder in the second negative electrode active material layer.

7. The negative electrode as claimed in claim 1, wherein a weight ratio of the first binder to the second binder is in a range of about 60:40 to about 90:10, based on a total amount of the first and second binders.

8. The negative electrode as claimed in claim 1, wherein the first negative electrode active material layer comprises:
a first surface portion adjacent to the surface of the first negative electrode active material layer; and
a first deep portion between the first surface portion and the negative electrode current collector, and
wherein a mixture density of the first surface portion is less than a mixture density of the first deep portion.

9. The negative electrode as claimed in claim 8, wherein an amount of the first binder in the first surface portion is less than an amount of the second binder in the first deep portion, and
wherein a porosity of the first surface portion is greater than a porosity of the first deep portion.

10. The negative electrode as claimed in claim 1, wherein the second negative electrode active material layer comprises:
a second surface portion adjacent to the first surface of the second negative electrode active material layer; and
a second deep portion between the second surface portion and the first negative electrode active material layer, and
wherein a mixture density of the second surface portion is less than a mixture density of the second deep portion.

11. The negative electrode as claimed in claim 10, wherein an amount of the second binder in the second surface portion is less than the amount of the second binder in the second deep portion, and
wherein a porosity of the second surface portion is greater than a porosity of the second deep portion.

12. A method for manufacturing a negative electrode, the method comprising:
preparing a negative electrode current collector;
forming a first negative electrode active material layer on the negative electrode current collector;
forming a second negative electrode active material layer on the first negative electrode active material layer; and
performing a surface treatment process on at least one of the first negative electrode active material layer and the second negative electrode active material layer to remove a binder in a surface portion.

13. The method as claimed in claim 12, wherein the first negative electrode active material layer comprises:
a first surface portion adjacent to a surface of the first negative electrode active material layer; and
a first deep portion between the first surface portion and the negative electrode current collector,
wherein removing the binder comprises performing a first surface treatment process on the surface of the first negative electrode active material layer to remove the binder in the first surface portion, and
wherein a mixture density of the first surface portion is less than a mixture density of the first deep portion.

14. The method as claimed in claim 12, wherein the second negative electrode active material layer comprises:
a second surface portion adjacent to one surface of the second negative electrode active material layer; and
a second deep portion between the second surface portion and the first negative electrode active material layer,
wherein removing the binder comprises performing a second surface treatment process on the one surface of the second negative electrode active material layer to remove the binder in the second surface portion, and
wherein a mixture density of the second surface portion is less than a mixture density of the second deep portion.

15. The method as claimed in claim 13, wherein an amount of the binder in the first surface portion is less than the amount of the binder in the first deep portion, and
wherein a porosity of the first surface portion is greater than a porosity of the first deep portion.

16. The method as claimed in claim 14,
wherein an amount of the binder in the second surface portion is less than the amount of the binder in the second deep portion, and
wherein a porosity of the second surface portion is greater than a porosity of the second deep portion.

17. The method as claimed in claim 12, wherein the surface treatment process is performed by a light irradiation using a flash lamp.

18. The method as claimed in claim 17, wherein the light irradiation comprises applying a voltage in a range of about 100 V to about 1000 V.

19. The method as claimed in claim 17, wherein the light irradiation is performed for a duration in a range of about 100 μs to about 2000 μs.

20. A rechargeable lithium battery comprising:
the negative electrode as claimed in claim 1;
a positive electrode; and
a separator between the negative electrode and the positive electrode.
